(19) United States
(12) Patent Application Publication
(10) Pub. No.: US 2008/0211625 A1
(43) Pub. Date: Sep. 4, 2008

(54) METHOD FOR TEMPORARILY INHIBITING, WHEN IT HAS BEEN DETECTED INSIDE A LOCKED VEHICLE, A PORTABLE REMOTE CONTROL UNIT KNOWN AS A TAG BELONGING TO A KEYLESS ENTRY DEVICE

(75) Inventors: Alain BRILLON, Villeneuve Tolosane (FR); Valerie Escarpit, Fontenilles (FR)

Correspondence Address: YOUNG & THOMPSON, 209 Madison Street, Suite 500, ALEXANDRIA, VA, 22314, US

(73) Assignee: CONTINENTAL AUTOMOTIVE FRANCE, TOULOUSE (FR)

(21) Appl. No.: 12/039,760

(22) Filed: Feb. 29, 2008

(30) Foreign Application Priority Data
Mar. 1, 2007 (FR) 07/01486

(51) Int. Cl. G08C 19/02

(52) U.S. Cl. 340/5.61; 340/10.1

(57) ABSTRACT

A method for temporarily inhibiting, when it is detected inside a locked vehicle, a portable remote control unit, known as a tag, of a keyless entry device designed to implement access authorization procedures to allow access to the vehicle, these including an initial identification procedure which includes causing a central processing unit to periodically transmit a data frame incorporating a preamble consisting of a predefined wake-up code that can be identified by the tag. The inhibition method include defining a first wake-up code at least intended for the procedure of temporarily inhibiting the tags, and a second wake-up code specifically intended for the procedure of identifying the tags, and in setting up temporary inhibition procedures which consist in causing a specific data frame incorporating, in its preamble, the first wake-up code and designed to deactivate the recognition, by each target tag, of the second wake-up code, to be transmitted.

The invention relates to a method for temporarily inhibiting, when it has been detected inside a locked vehicle, a portable remote control unit, known as a tag, belonging to a keyless entry device.

Devices providing keyless entry to a vehicle conventionally comprise a portable remote control unit, known as a tag, a central processing unit on board the vehicle, and transmission means on the one hand located inside the vehicle and on the other hand incorporated into the tag and designed to allow a dialog to be set up between the central processing unit and said tag with a view to implementing vehicle access authorization procedures.

Present day conventional keyless entry devices also comprise a proximity sensor designed to be installed in a door handle so as to detect the hand of an individual actuating this door handle and, when it is activated, to trigger a procedure whereby the tag worn or carried by this individual is identified.

One of the disadvantages with these keyless entry devices stems from the need for the door to have been unlocked before the door handle is fully actuated, otherwise the locking mechanism jams, preventing the door from being opened.

The net result of this requirement is that the time set aside for performing the identification and unlocking operations is often too short, which means that the door does not unlock the first time it is actuated (an incident known as “wall effect”).

With a view in particular to alleviating this disadvantage which proves troublesome to vehicle owners, one evolution has been to produce keyless entry devices designed to allow the, tags to be identified as soon as they enter an area, known as the area of coverage, of predetermined range around the vehicles.

To this end, these keyless entry devices are programmed to implement an identification procedure that consists in causing the central processing unit on board the vehicle periodically to transmit a data frame incorporating a preamble consisting of a predefined wake-up code that can be identified by the tag, the latter being programmed, once it has identified this wake-up code, to switch from a standby state to an active state so that a dialog with the central processing unit can be set up.

Entry devices of this kind also have the benefit of allowing the unlocking operation to be accompanied by the switching-on of certain lighting sources of the vehicle, such as, for example, the ceiling light, the door sill lights, etc., a function conventionally known by the term “welcome lighting”.

In practice, this identification procedure has, however, flagged up a disadvantage observed when a tag is unintentionally left in a vehicle. What actually happens in a scenario such as this is that, once the vehicle has been locked, the tag thus left is thereafter periodically woken up by the central processing unit, thus causing the battery incorporated into said tag to lose its charge quickly.

At the present time, the answer put forward in an attempt to alleviate this disadvantage is a temporary inhibition procedure whereby, when a tag is detected as being inside a vehicle after this vehicle has been locked, the “remote” tag identification procedure is disabled and this identification procedure has therefore to be triggered by activation of a proximity sensor built into a door handle.

A solution such as this solves the problem of energy consumption by tags left in vehicles, but does, on the other hand, prove disturbing to drivers of the vehicles because it disables the “welcome lighting” function and may also cause the phenomenon of “wall effect” to appear.

It is an object of the present invention to alleviate this disadvantage and the chief objective of the invention is to provide a temporary inhibition method that is entirely transparent to the user of the vehicle and solves the problem of energy consumption by tags unintentionally left in vehicles.

To this end, the invention is aimed at a method for temporarily inhibiting, when it is detected inside a locked vehicle, a portable remote control unit, known as a tag, of a keyless entry device comprising, aside from said tag, a central processing unit on board the vehicle and transmission means, on the one hand, located inside the vehicle and, on the other hand, incorporated into the tag and designed to allow a dialog to be set up between the central processing unit and the tag with a view to implementing access authorization procedures to allow access to the vehicle, these including an initial identification procedure which consists in causing the central processing unit periodically to transmit a data frame incorporating a preamble consisting of a predefined wake-up code that can be identified by the tag, the latter being programmed, having identified this wake-up code, to switch from a standby state to an active state so that a dialog can be set up with the central processing unit.

According to the invention, the inhibition method consists:
in defining a first wake-up code WUP1 at least intended for the procedure of temporarily inhibiting the tags,
in defining a second wake-up code WUP2 specifically intended for the procedure of identifying the tags,
and in setting up temporary inhibition procedures which consist, when a tag has been detected inside a locked vehicle, in causing the central processing unit to transmit to said tag a specific data frame incorporating, in its preamble, the first wake-up code WUP1 and designed to deactivate the recognition of the second wake-up code WUP2 by this tag.

According to this method, the data frame periodically transmitted by the central processing unit of a vehicle therefore comprises a wake-up code WUP2 specific to the identification procedure, and the temporary inhibition procedure consists in transmitting a data frame incorporating a different wake-up code WUP1 designed to deactivate recognition of the wake-up code WUP2 specific to the identification procedure in respect of the tag unintentionally left in the vehicle.

This principle therefore leads to a temporary inhibition of the operation of the tags detected as being inside the vehicles without, however, affecting the identification procedures in respect of the other tags, which means that the inhibition procedure is entirely transparent as far as the user is concerned.

According to one advantageous embodiment of the invention, with a view to ending the temporary inhibition procedure, once the vehicle has been unlocked, a specific data frame incorporating, in its preamble, the first wake-up code WUP1, and designed to reactivate recognition of the second wake-up code WUP2 by this tag is caused to be transmitted to each tag previously detected as being inside said vehicle.

Advantageously, according to the invention, two different wake-up codes are also advantageously defined:
a first wake-up code WUP1 of conventional type intended to be transmitted as a preamble of data frames relating to the temporary inhibition procedures and to the other various functions of the tags,
and a second wake-up code WUP2 specific to the procedure of identifying the tags and incorporating an identification code pertaining to the vehicle.

According to this principle, firstly, the data frames transmitted during the identification procedure incorporate the vehicle identification code which means that only tags belonging to this vehicle are “woken up” following analysis of said wake-up code and in return transmit a response.

Thus, energy consumption is optimized both in terms of the vehicles and in terms of the control units.

In addition, this embodiment consists in transmitting wake-up codes which are designed in favor of:
response times for all the functions of the tags initiated at specific moments in time and therefore not liable to cause significant energy consumption because of this initiation specifically at isolated points in time,
energy consumption during identification procedures which are periodic in nature.

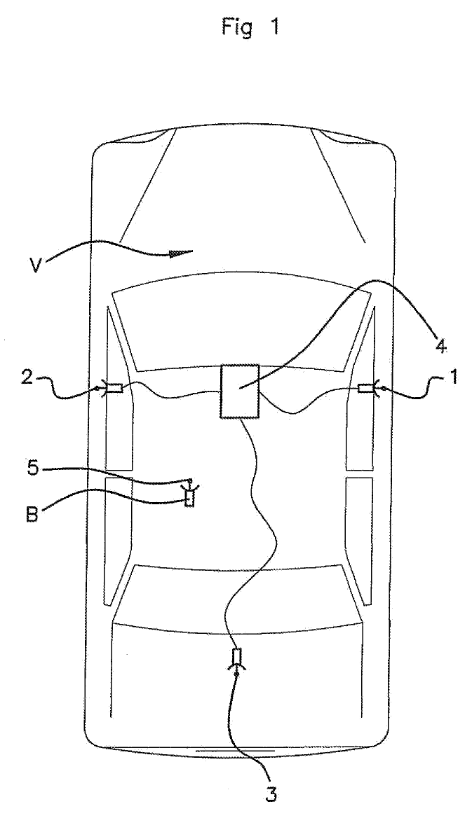

Other features, objects and advantages of the invention will become apparent from the detailed description which follows, with reference to the attached drawing which by way of nonlimiting example depicts a preferred embodiment thereof. In this drawing, the single FIG. 1 is a schematic view from above of a vehicle equipped with a keyless entry system according to the invention.

The invention depicted in FIG. 1 is aimed at a device normally known as a “keyless entry system” designed to allow a vehicle V to be entered, and possibly started, by virtue of the identification of a portable remote control unit B commonly known as an “electronic badge” or tag.

In the customary way and as depicted in FIG. 1, a keyless entry system such as this comprises, firstly, antennas such as 1 to 3 positioned inside (not depicted) and outside the vehicle V and connected to a central processing unit 4 on board said vehicle and provided with a computer incorporating a low frequency “LF” transmitter and a radiofrequency “RF” receiver.

It should be noted that, for the purposes of simplifying matters, only three external antennas 1-3, in this instance positioned on the side doors and on the door providing access to the luggage compartment of the vehicle V has been depicted in FIG. 1. However, the keyless entry device according to the invention also, in the conventional way, comprises internal antennas and an RF reception antenna usually incorporated into the central processing unit 4.

The tag B of this keyless entry system comprises, for its part, a computer incorporating a low frequency “LF” receiver and a radiofrequency “RF” transmitter which are connected to antennas such as 5.

In the usual way, such keyless entry systems are designed in particular to allow automatic unlocking of the doors of a vehicle V following identification of a tag B by the central processing unit 4 of this vehicle V in a predefined area of coverage around the vehicle V.

In addition, in order to allow the doors of the vehicle V to be unlocked automatically:
the central processing unit 4 is programmed to periodically transmit a data frame consisting of a predefined wake-up code WUP1 that the tag B can identify,
and this tag B is programmed, having identified the wake-up code WUP2, to switch from a standby state to an active, state in which it sets up a dialog with the central processing unit.

Furthermore, the data frame periodically transmitted by the central processing unit 4 advantageously defines a four-byte wake-up code WUP2 specifically intended for the procedure of identifying the tags B, and broken down into:
a first byte specific to the “welcome lighting” function, which is identical to all vehicles on the same platform,
and a further three bytes specific to each vehicle and representative of the identification code VIN of said vehicle.

By contrast, the data frame transmitted by the central processing unit 4 for all the other functions of the tags B, namely the inhibition procedures according to the invention as described hereinabove, and, for example, to control locking, starting, diagnostics functions etc., are of a conventional type and incorporate:
a first byte defining a conventional wake-up code WUP1 which is identical for all vehicles on the same platform,
a second byte FC defining the function targeted by the data frame, that is to say control intended to be performed once the tag B has been woken up,
and x bytes defining function-specific useful data.

On the basis of the principles explained hereinabove, the temporary inhibition procedure triggered according to the invention, when a tag B has been unintentionally left and then detected as being inside a locked vehicle V, consists in causing the central processing unit 4 to transmit to said tag a data frame incorporating:
a first byte defining the conventional wake-up code WUP1,
and n bytes controlling deactivation of the recognition of the wake-up code WUP2 by the tag B.

Thus, the tag B is no longer involved in the identification procedure and this is true until such time as the central processing unit 4, following unlocking of the vehicle V, transmits a data frame incorporating the first wake-up code WUP1 and designed to reactivate recognition, by this tag B, of the second wake-up code WUP2.

An inhibition procedure such as this therefore causes operation of the tags B detected as being inside vehicles V to be inhibited temporarily without, however, affecting the procedures of identifying the other tags B, particularly those worn or carried by the users of the vehicles V, such that this inhibition procedure is entirely transparent to the user and does not disable any of the “keyless” functions performed by badges outside the vehicle.

1. A method for temporarily inhibiting, when it is detected inside a locked vehicle (V), a portable remote control unit (B), known as a tag, of a keyless entry device comprising, aside from said tag, a central processing unit (4) on board the vehicle (V) and transmission means (1-3, 5), on the one hand, located inside the vehicle (V) and, on the other hand, incorporated into the tag (B) and designed to allow a dialog to be set up between the central processing unit (4) and the tag (B) with a view to implementing access authorization procedures to allow access to the vehicle (V), these including an initial identification procedure which consists in causing the central processing unit (4) periodically to transmit a data frame incorporating a preamble consisting of a predefined wake-up code that can be identified by the tag (B), the latter being programmed, having identified this wake-up code, to switch from a standby state to an active state so that a dialog can be set up with the central processing unit (4), said inhibition method being characterized in that it consists:
in defining a first wake-up code WUP1 at least intended for the procedure of temporarily inhibiting the tags (B),
in defining a second wake-up code WUP2 specifically intended for the procedure of identifying the tags (B),
and in setting up temporary inhibition procedures which consist, when a tag (B) has been detected inside a locked vehicle (V), in causing the central processing unit (4) to transmit to said tag a specific data frame incorporating, in its preamble, the first wake-up code WUP1 and designed to deactivate the recognition of the second wake-up code WUP2 by this tag (B).

2. The inhibition method, as claimed in claim 1, characterized in that it consists, once the vehicle (V) has been unlocked, in causing a specific data frame incorporating, in its preamble, the first wake-up code WUP1, and designed to reactivate recognition of the second wake-up code WUP2 by this tag (B) to be transmitted to each tag (B) previously detected as being inside said vehicle.

3. The inhibition method as claimed in claim 1, characterized in that two different wake-up codes are defined:
a first wake-up code WUP1 of conventional type intended to be transmitted as a preamble of data frames relating to the temporary inhibition procedures and to the other various functions of the tags (B),
and a second wake-up code WUP2 specific to the procedure of identifying the tags (B) and incorporating an identification code pertaining to the vehicle (V).

4. The inhibition method as claimed in claim 2, characterized in that two different wake-up codes are defined:
a first wake-up code WUP1 of conventional type intended to be transmitted as a preamble of data frames relating to the temporary inhibition procedures and to the other various functions of the tags (B),
and a second wake-up code WUP2 specific to the procedure of identifying the tags (B) and incorporating an identification code pertaining to the vehicle (V).
